(19) United States
(12) Patent Application Publication
(10) Pub. No.: US 2021/0264907 A1
(43) Pub. Date: Aug. 26, 2021

(54) OPTIMIZATION OF VOICE INPUT PROCESSING

(71) Applicant: Lenovo (Singapore) Pte. Ltd., Singapore (SG)

(72) Inventors: John Carl Mese, Cary, NC (US); Nathan J. Peterson, Oxford, NC (US); Arnold S. Weksler, Raleigh, NC (US); Russell Speight VanBlon, Raleigh, NC (US); Mark Patrick Delaney, Raleigh, NC (US)

(21) Appl. No.: 16/795,889

(22) Filed: Feb. 20, 2020

(51) Int. Cl. G10L 15/22; H04R 1/32; G10L 15/24; G06T 7/70

(52) U.S. Cl. CPC G10L 15/22; H04R 1/326; G06T 2207/30196; G06T 7/70; G10L 15/24

(57) ABSTRACT

One embodiment provides a method, including: identifying, using an information handling device, a position of at least one user in a space; focusing, prior to receiving voice input from the at least one user, a microphone beam on the position; and optimizing, based on the focusing, processing of the voice input received from the position associated with the at least one user. Other aspects are described and claimed.

### BACKGROUND

The popularity of digital assistants and dedicated digital assistant devices has increased in recent years. Such systems allow a user to interact with an information handling device (“device”), for example a smart phone, a tablet, a smart speaker, a laptop and/or personal computer, and the like, in a more natural way (e.g., through the use of natural language voice input, etc.). More particularly, digital assistants are capable of detecting voice input, processing it, and thereafter generating some type of output that corresponds to the voice input.

### BRIEF SUMMARY

In summary, one aspect provides a method, comprising: identifying, using an information handling device, a position of at least one user in a space; focusing, prior to receiving voice input from the at least one user, a microphone beam on the position; and optimizing, based on the focusing, processing of the voice input received from the position associated with the at least one user.

Another aspect provides an information handling device, comprising: at least one sensor; a processor; a memory device that stores instructions executable by the processor to: identify a position of at least one user in a space; focus, prior to receiving voice input from the at least one user, a microphone beam on the position; and optimize, based on the focusing, processing of the voice input received from the position associated with the at least one user.

A further aspect provides a product, comprising: a storage device that stores code, the code being executable by a processor and comprising: code that identifies a position of at least one user in a space; code that focuses, prior to receiving voice input from the at least one user, a microphone beam on the position; and code that optimizes, based on the focusing, processing of the voice input received from the position associated with the at least one user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of optimizing the processing of voice input.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently interact with devices to obtain information and/or to request performance of various commands. One method of interacting with a device is to use digital assistant software employed on the device. Users may provide command input (e.g., voice input, etc.) to the digital assistant and, responsive to receiving the command input, the digital assistant may perform a corresponding task (e.g., retrieve requested information, take a requested action, etc.).

To improve the processing of detected voice input, some conventional devices utilize a multi-microphone array. This array may emphasize speech input provided from a desired direction and may also correspondingly suppress audio interference detected from other directions. To do this, however, the device must first identify the source location. Conventional techniques for identifying the source location involve detecting particular types of audio (e.g., wake words, etc.). Once this audio is detected, these devices may utilize existing beamforming techniques to focus in on the location.

When interacting with voice-capable devices, the direction from which the incoming audio is received is important for devices to be able to effectively parse the user's speech. However, the detected direction can sometimes be inaccurate. For example, audio may bounce off nearby walls, a user may be moving during speech provision, multiple users may be speaking from different positions, etc. In these situations, if the source location of the detected audio is incorrectly identified, the quality of the parsed speech may suffer.

Accordingly, an embodiment provides a method for improving audio processing by identifying the positions of users in a space. In an embodiment, a position of one or more users in a space may be identified. The identification of the user positions may be facilitated using one or more means (e.g., based upon detected signals from a user's device, based upon audio and/or visual data received from one or more sensors on the digital assistant device, etc.). After the positions of the users are identified, an embodiment may beamform, or focus, a microphone beam on those positions. The beamforming may occur before any type of voice input (e.g., a wake word, etc.) is detected. Based on this focusing, the processing of voice inputs received from these positions may be optimized. Such a method may improve the processing of voice inputs provided by users in a space.

The illustrated example embodiments will be best understood by reference to the figures. The following description is intended only by way of example, and simply illustrates certain example embodiments.

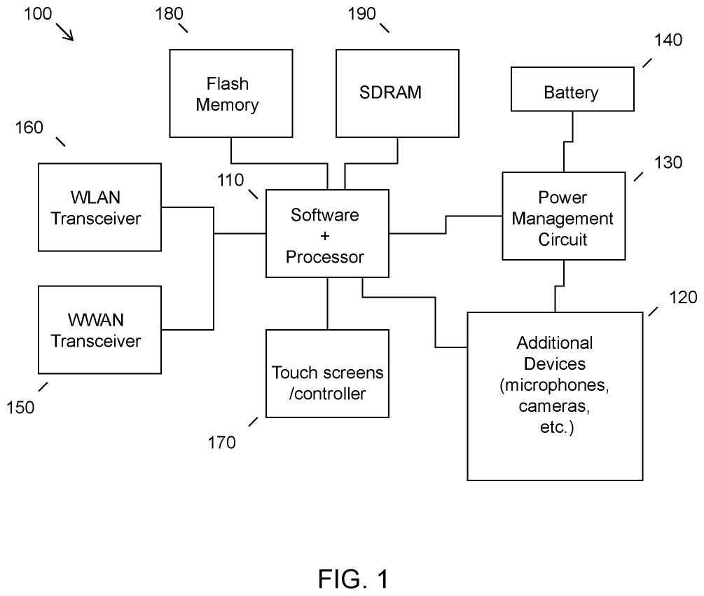

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

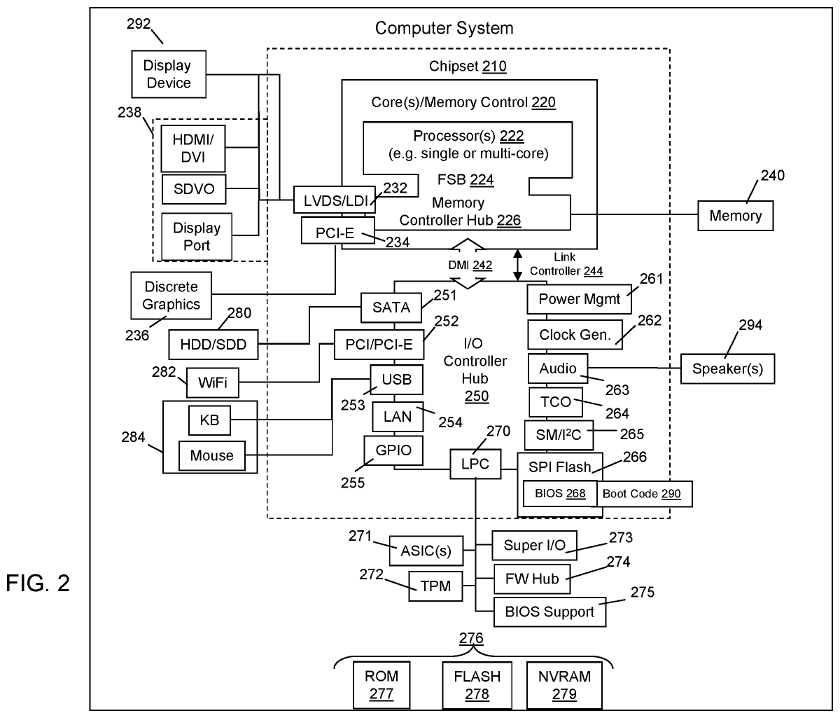

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices capable of receiving user inputs and providing corresponding outputs to those inputs. For example, the circuitry outlined in FIG. 1 may be implemented in a smart phone or tablet embodiment, whereas the circuitry outlined in FIG. 2 may be implemented in a laptop.

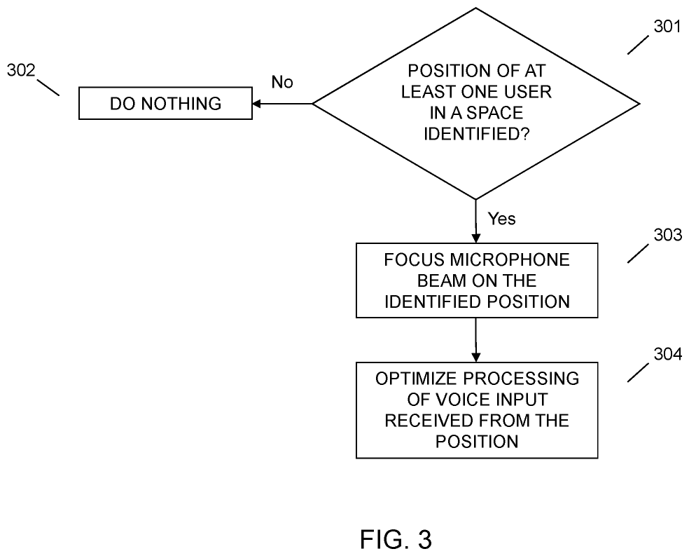

Referring now to FIG. 3, an embodiment provides a method for optimizing voice input based upon an identified position of a user in a space. At 301, an embodiment may utilize a digital assistant device to identify a position of at least one user in a space. In an embodiment, the digital assistant device may be virtually any device capable of detecting and processing user voice inputs.

In an embodiment, the user's position may be identified using one or more techniques. For example, the digital assistant device may receive a signal from a device associated with a position a user is located. More particularly, the user's device may be a device carried by the user, worn by the user, positioned in front of the user, etc. In this regard, the user's device may be a smart phone, tablet, wearable device (e.g., smart watch, etc.), and the like. The signal emitted by the user's device may be virtually any type of signal that is able to be detected by other devices and that may be used to identify the position of the user's device. In an embodiment, the user's device may continually emit the signal that may correspondingly be detected by the digital assistant device, which may continually monitor for the signal. Alternatively, the user's device may only emit the signal in response to receiving a signal output request from the digital assistant device.

In an embodiment, the user's position may also be identified by using one or more sensors integrated or operatively coupled to the digital assistant device. For example, one or more camera sensors may be utilized to capture one or more images of a space, which may thereafter be analyzed to determine whether any individuals are present in the image(s). In another example, one or more motion sensors and/or thermal sensors may be used to detect whether any motion occurs at a location in the space. In an embodiment, the motion sensors may be primed to monitor for human motions and to disregard motion produced by other objects (e.g., pets, etc.).

Responsive to identifying, at 301, that no users are detected in the space, an embodiment may, at 302, take no further action. Alternatively, responsive to detecting that at least one user was detected in the space, an embodiment may, at 303, focus a microphone beam on the position. In an embodiment, the focusing of the beam may be facilitated by using one or more known beam forming techniques known in the art. Additionally, it is important to the note that an embodiment may focus in on a position prior to receiving or detecting any audible input from that position.

At 304, an embodiment may optimize, based on the focused microphone beam, processing of voice input detected from the position. In a broad sense, the optimized processing may refer to more accurate parsing and analysis of the voice input. Additionally or alternatively, the optimized processing may filter out extraneous sounds (e.g., other types of voice inputs, other sounds, etc.) that are detected from other positions in the space not associated with the user's position.

An embodiment may also determine an identity of a user using one or more of the following techniques. For example, the digital assistant device may receive a signal from the user's device that indicates the user's identity. In another example, the digital assistant device may receive a device identifying signal from the user's device that may thereafter be compared to an accessible database (e.g., stored locally on the device, stored remotely on another device, etc.), which contains a list of associations between user identities and their devices. In yet another example, an embodiment may utilize one or more camera sensors to capture one or more images of any users in the space. An embodiment may thereafter analyze the image(s) (e.g., using one or more conventional image analysis techniques, etc.) to determine the identities of any users.

In an embodiment, the optimization of the processing of the voice input may be supplemented by the determination of the user's identity. For example, responsive to determining a user's identity, an embodiment may access a user profile associated with the user. The user profile may contain, inter alia, a voice profile for the user. An embodiment may utilize this voice profile to better process voice inputs received from the identified user(s). As another example, an embodiment may reference the user's profile to identify another characteristic associated with the user. In an embodiment, the other characteristic may correspond to an age and/or gender of the user. Having knowledge of these data points may be valuable to a system in order to better know how to process received voice inputs. More particularly, the voice profiles of women and children may be more difficult to parse and process than the voice profiles of men (e.g., due to higher tone and/or pitch, greater diversity between individuals in tone and/or pitch, etc.). Responsive to identifying that a voice-providing user was a woman or a child, an embodiment may adjust a processing metric to better process voice input provided by those individuals.

In an embodiment, a task attempted to be performed by one or more of the users in the space may be determined. The determination of the task may be facilitated via one or more techniques. For example, an embodiment may have access to context data associated with one or more of the users in the space (e.g., social media data, calendar data, communication data, etc.). An analysis of this context data may reveal a task to be performed by one or more of these users (e.g., a cooking task, a shopping task, a construction task, a problem-solving task, etc.). As another example, during the interactive session between the digital assistant and the user(s), an indication may be received by the digital assistant device of the task. In yet another example, an audio capture device (e.g., a microphone, etc.) associated with the digital assistant device may be always on. An embodiment may utilize this always-on microphone to detect the conversation between users in the space and detect an indication of a discussed task in their conversation.

An embodiment may utilize knowledge of the task, along with user identity data, to focus on certain positions in a space and correspondingly optimize voice input received from that position. As a non-limiting example of the foregoing concepts, an embodiment may determine that there are six users in a space and that three of them are involved in performance of a particular task. Responsive to this determination, an embodiment may focus microphone beams on the positions of the three, task-involved users. This may prime the digital assistant device to better capture and/or process the voice inputs provided from these positions.

The various embodiments described herein thus represent a technical improvement to conventional methods of optimizing the processing of user voice inputs. Using the techniques described herein, an embodiment may identify a position of at least one user in a space. Thereafter, an embodiment may focus a microphone beam onto this position and correspondingly optimize the processing of voice inputs received from this position. Such a method may overcome the conventional issues related to source position identification and correspondingly improve the accuracy and quality of received voice input.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
identifying, using an information handling device, a position of at least one user in a space;
focusing, prior to receiving voice input from the at least one user, a microphone beam on the position; and
optimizing, based on the focusing, processing of the voice input received from the position associated with the at least one user.

2. The method of claim 1, wherein the identifying the position comprises receiving a signal from another device associated with the at least one user.

3. The method of claim 1, wherein the identifying the position comprises identifying the position using at least one sensor selected from the group consisting of a camera sensor and a microphone.

4. The method of claim 1, wherein the optimizing comprises filtering out extraneous voice input received from other positions in the space.

5. The method of claim 1, further comprising determining, using at least one sensor, an identity of the user.

6. The method of claim 5, wherein the optimizing the processing of the voice input comprises:
accessing, based on the determining, a user profile associated with the user; and
optimizing the processing of the voice input based on the user profile.

7. The method of claim 5, further comprising identifying, based upon the determined identity of the user, a characteristic associated with the user, wherein the characteristic corresponds to at least one of: an age of the user and a gender of the user.

8. The method of claim 7, wherein the optimizing comprises adjusting a metric for the processing of the voice input based upon the characteristic.

9. The method of claim 5, further comprising identifying a task attempting to be performed by the at least one user.

10. The method of claim 9, wherein the focusing comprises focusing the microphone beam on the position associated with each of the at least one users involved in the performance of the task.

11. An information handling device, comprising:
at least one sensor;
a processor;
a memory device that stores instructions executable by the processor to:
identify a position of at least one user in a space;
focus, prior to receiving voice input from the at least one user, a microphone beam on the position; and
optimize, based on the focusing, processing of the voice input received from the position associated with the at least one user.

12. The information handling device of claim 11, wherein the instructions executable by the processor to identify the position comprise instructions executable by the processor to receive a signal from another device associated with the at least one user.

13. The information handling device of claim 11, wherein the instructions executable by the processor to identify the position comprise instructions executable by the processor to identify the position using at least one sensor selected from the group consisting of a camera sensor and a microphone.

14. The information handling device of claim 11, wherein the instructions executable by the processor to optimize comprise instructions executable by the processor to filter out extraneous voice input received from other positions in the space.

15. The information handling device of claim 11, wherein the instructions are further executable by the processor to determine, using at least one sensor, an identify of the user.

16. The information handling device of claim 15, wherein the instructions executable by the processor to optimize the processing of the voice input comprise instructions executable by the processor to:
access, based on the determining, a user profile associated with the user; and
optimize the processing of the voice input based on the user profile.

17. The information handling device of claim 15, wherein the instructions are further executable by the processor to identify, based upon the determined identity of the user, a characteristic associated with the user, wherein the characteristic corresponds to at least one of: an age of the user and a gender of the user.

18. The information handling device of claim 17, wherein the instructions executable by the processor to optimize comprise instructions executable by the processor to adjust a metric for the processing of the voice input based upon the characteristic.

19. The information handling device of claim 15, wherein the instructions are further executable by the processor to identify a task attempting to be performed by the at least one user and wherein the instructions executable by the processor to focus comprise instructions executable by the processor to focus the microphone beam on the position associated with each of the at least one users involved in the performance of the task.

20. A product, comprising:
a storage device that stores code, the code being executable by a processor and comprising:
code that identifies a position of at least one user in a space;
code that focuses, prior to receiving voice input from the at least one user, a microphone beam on the position; and
code that optimizes, based on the focusing, processing of the voice input received from the position associated with the at least one user.
